(19) United States
(12) Patent Application Publication
(10) Pub. No.: US 2023/0404722 A1
(43) Pub. Date: Dec. 21, 2023

(54) PCD END-MILLS FOR DENTAL CROWN

(71) Applicant: Telcon Diamond Ltd., Afula (IL)

(72) Inventors: MOSHE BEN SIMON, Tzipori (IL); Sawser Hatukay Kfar Kama, Kfar Kama (IL); Moti Baron, Kfar Vradim (IL)

(73) Assignee: Telcon Diamond Ltd., Afula (IL)

(21) Appl. No.: 18/038,030

(22) PCT Filed: Jan. 19, 2022
(86) PCT No.: PCT/IL2022/050077

§ 371 Date: May 22, 2023

Related U.S. Application Data
(60) Provisional application No. 63/149,310, filed on Feb. 14, 2021.

(51) Int. Cl. A61C 13/00

(52) U.S. Cl. CPC A61C 13/0006; A61C 13/0004

(57) ABSTRACT

Some embodiments of the current invention include a super hard cutting tool configured for use in an existing Computer Aided Milling (CAM) machine. For example, a diamond tool may be configured to replace a Tungsten Carbide (WC) cutting tool used in an existing CAM machine. Optionally, the diamond tool may use a Polycrystalline diamond (for example a PCD tip). Optionally, the super hard tip will have the same geometry and/or substantially the same geometry as a convention WC tool. For example, the super hard tool may be used to work (e.g., mill) a green blank (e.g., non sintered zirconium). Some embodiments of the current invention include working a fully hardened dental prosthesis. For example, a super hard cutting tool may be used to work a fully hardened blank to for the prosthesis (e.g., sintered zirconium).

### RELATED APPLICATION/S

This application is a Continuation in part of International Patent Application PCT/IL2022/05007 filed Jan. 19, 2022 which claims the benefit of priority of U.S. Provisional Patent Application No. 63/149,310 filed 14 Feb. 2021.

This application claims the benefit of priority of International Patent Application PCT/IL2022/05007 filed Jan. 19, 2022 and claims the benefit of priority under 35 USC § 119(e) of U.S. Provisional Patent Application No. 63/149,310 filed 14 Feb. 2021, the contents of all of which are incorporated herein by reference in their 20 entirety.

### FIELD AND BACKGROUND OF THE INVENTION

The present invention, in some embodiments thereof, relates to a diamond tool and, more particularly, but not exclusively, to a tool for milling dental prosthesis.

U.S. Pat. No. 9,918,806 appears to disclose that “Milling strategies for machining dental ceramic materials are provided that reduce milling time while maintaining strength, accuracy and marginal integrity.”

U.S. patent Ser. No. 10/258,440 appears to disclose that “A method is provided for shaping a custom dental restoration from a preform, wherein the preform comprises a preform body and a preform stem. A method is further disclosed for generating one or more nesting positions for the restoration design within the geometry of the preform body relative to the position of the preform stem. A method is further disclosed for generating machining instructions based on the selected nesting position to optimize machining for chair-side applications.”

U.S. patent Ser. No. 10/258,440 appears to disclose that “Methods and apparatus that permit a dentist to provide a patient with a monolithic ceramic dental restoration (e.g., crown, bridge, or the like) in one office visit. In some embodiments, a dentist is provided with a kit containing one or more near net shape (NNS) millable blanks of various shapes and shades, chair-side software, and a chair-side milling machine to convert a selected millable blank into a finished, fully contoured restoration in about one hour or less. Each such millable blank may be, for example, a dental ceramic (e.g., fully sintered zirconia, fully crystallized lithium silicate, fully crystallized lithium disilicate, or the like) NNS component. In some embodiments, the NNS component includes an integral mandrel at a precise location and orientation to minimize the amount of milling time.”

US Patent Application Publication no. 20070111161 appears to disclose, that “Diamond burs for dentistry are especially useful in application to porcelain and ceramics. Burs manufactured using a synthetic diamond grit of the type MBG® demonstrate exceptional useful properties in working with porcelain and hard ceramics including zirconia prosthodontics.”

US Patent Application Publication no. 20170035537 appears to disclose that “A machinable preform for shaping into dental restorations is described that comprises material having suitable strength for use in dental applications without requiring further processing after shaping to strengthen the material (such as sintering). In one embodiment, a preform is comprised of a machinable dental material having a Vickers hardness value in the range of 4HV GPa to 20HV GPa, and comprises a body and a stem that extends from the outer surface of the body that supports the body during shaping. A method for making the machinable preform, and a kit comprising a machinable preform and a grinding tool, are also described.”

Other art includes Gregg A. Helvey, Zirconia and Computer-aided Design/Computer-aided Manufacturing (CAD/CAM) Dentistry, AEGIS Dental Network, Special Issue October 2007. A. B Hadzley, T. Norfauzi, U. A. A Umar, A. A. Afuza, M. M. Faiz and M. F. Naim; Effect of sintering temperature on density, hardness and tool wear for alumina-zirconia cutting tool Journal of Mechanical Engineering and Sciences; ISSN (Print): 2289-4659; e-ISSN: 2231-8380; Volume 13, Issue 1, pp. 4648-4660, March 2019; © Universiti Malaysia Pahang, Malaysia; DOI: 10.15282

### SUMMARY OF THE INVENTION

According to an aspect of some embodiments of the invention, there is provided a tool for an existing CAD CAM milling machine including a super hard tip.

According to some embodiments of the invention, the super hard tip includes a diamond material.

According to some embodiments of the invention, the super hard tip includes a PCD.

According to some embodiments of the invention, the flute length of the tool is less than a convention WC tool.

According to some embodiments of the invention, the flute length of the tool is more than a convention WC tool.

According to an aspect of some embodiments of the invention, there is provided a tool for CAD CAM milling of a fully hardened dental prosthesis having a super hard tip.

According to some embodiments of the invention, the super hard tip includes a hard diamond material.

According to some embodiments of the invention, the super hard tip includes a PCD.

According to an aspect of some embodiments of the invention, there is provided a method of cutting a dental prosthesis from a blank including: supplying a fully hardened blank; supplying a super hard tipped tool; cutting the dental prosthesis from the fully hardened blank using the super hard tipped tool.

According to some embodiments of the invention, the super hard tipped tool includes a PCD tip.

According to some embodiments of the invention, the method further includes cutting multiple prostheses from the blank.

According to some embodiments of the invention, the fully hardened blank includes a hard ceramic.

According to some embodiments of the invention, the fully hardened blank includes sintered zirconium.

According to an aspect of some embodiments of the invention, there is provided a method of cutting a dental prosthesis from a blank including: supplying a green blank supplying a super hard tipped tool cutting the dental prosthesis from the green blank using the super hard tipped tool; sintering the dental prosthesis after the cutting.

According to some embodiments of the invention, the super hard tipped tool includes a PCD tip.

According to some embodiments of the invention, the method further includes cutting multiple prostheses from the blank.

According to some embodiments of the invention, the method wherein the green blank includes non sintered zirconium.

According to an aspect of some embodiments of the invention, there is provided a tool in accordance with any combination of embodiments disclosed herein.

According to some embodiments of the invention, the tool includes a super hard cutting edge.

According to some embodiments of the invention, the tool is configured for use in an existing CAM dental milling machine.

According to some embodiments of the invention, the tool is configured for use in any cad cam machining center.

According to an aspect of some embodiments of the invention, there is provided a method of machining in accordance with any combination of embodiments disclosed herein.

According to some embodiments of the invention, the method includes milling a dental prosthesis from a green blank.

According to some embodiments of the invention, the method includes milling a dental prosthesis from a green blank.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE SEVERAL VIEWS OF THE DRAWING(S)

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 illustrates a super hard (e.g., PCD) tipped tool in accordance with an embodiment of the current invention compared to a conventional (e.g., WC) tool;

FIG. 2 is a block diagram of a super hard tipped tool in accordance with an embodiment of the current invention;

FIG. 3A is an illustration of some exemplary specifications for an end mill in accordance with an embodiment of the current invention;

FIGS. 3B and 3C illustrate some exemplary tools in accordance with an embodiment of the current invention;

FIG. 4A is an illustration of some exemplary specifications for a super hard tipped tool in accordance with an embodiment of the current invention;

FIGS. 4B and 4C illustrate some exemplary tools in accordance with an embodiment of the current invention;

FIG. 5A is an illustration of some exemplary specifications for an end mill in accordance with an embodiment of the current invention;

FIGS. 5B and 5C illustrate some exemplary tools in accordance with an embodiment of the current invention;

FIG. 6 is an illustration of the hardness of some exemplary materials that may be used for a machining tool in accordance with an embodiment of the current invention;

FIGS. 7 to 9 are flow chart illustrations of methods of CAD CAM machining in accordance with an embodiment of the current invention;

FIG. 10 illustrates machining multiple dental prostheses from a single block of material in accordance with an embodiment of the current invention; and

FIG. 11 is an image of an exemplary prosthetic in accordance with an embodiment of the current invention.

### DESCRIPTION OF SPECIFIC EMBODIMENTS OF THE INVENTION

The present invention, in some embodiments thereof, relates to a diamond tool and, more particularly, but not exclusively, to a tool for milling dental prosthesis.

### Overview

An aspect of some embodiments of the current invention relates to using a super hard cutting tool in an existing Computer Aided Milling (CAM) machine. For example, a diamond tool may be configured to replace a Tungsten Carbide (WC) cutting tool used in an existing CAM machine. Optionally, the diamond tool may use a Polycrystalline diamond (for example a PCD tip). For example, a single point diamond tool may be used. For example, the tool may have a super hard insert (e.g., Polycrystalline diamond and/or polydiamond). Optionally, the super hard tip will have the same geometry and/or substantially the same geometry as a conventional WC tool. In some embodiments, the super hard tool may be used to replace an existing conventional tool. For example, the super hard tool may be used to work (e.g., mill) a green blank (e.g., non sintered zirconium). In some embodiments the tool may have a ball tip. Alternatively or additionally, the tip may have a square end and/or square end with a rounded corner. For example, the rounded corner radius of the end mill may range between 0 to ½ of the diameter of the tool D. For example, a ball nose would have a corner radius=½ and/or a total “square end” would have a corner radius of 0.

An aspect of some embodiments of the current invention relates to working a fully hardened dental prosthesis. For example, a super hard cutting tool may be used to work a fully hardened blank to form the prosthesis (e.g., sintered zirconium).

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

Referring now to the drawings:

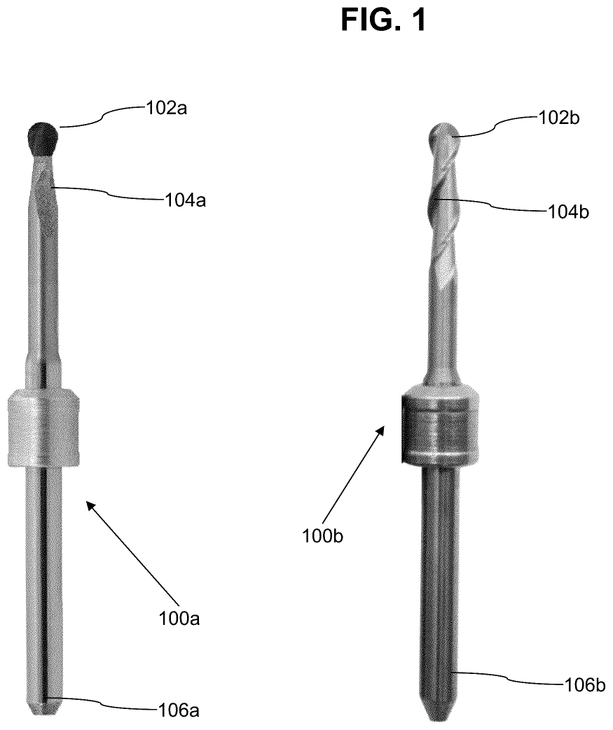

FIG. 1 is an image of a super hard (e.g., PCD) tipped tool 100a (e.g., a milling bit) in accordance with an embodiment of the current invention compared to a conventional (e.g., WC) tool 100b. For example, the super hard tool 100a may be made in same sizes (e.g., various ranges of sizes) as conventional tools. In some embodiments, the entire tip 102a of the tool 100a is made of a super hard material (e.g., PCD). The tool 100a may optionally be designed to fit into a standard Computer Aided Milling Machine (CAM). For example, the CAM may be used without modification. For example, the bit and/or the CAM machine may be stopped, the super hard tool 100a may be put in place of the conventional tool 100b and the cycle of the CAM machine restarted. Optionally, the tool 100a may perform the same as a conventional tool 100b (optionally with the additional advantages of the super hard material—sharper, longer lasting tip 102a than the tip 102b of the conventional tool 100b, able to mill harder materials, faster etc.). Optionally the length of a flute 104a of a super hard tipped tool may be shorter than a length of a flute 104b of a similar conventional WC tool. The shank 106a of the super hard tool 100a is optionally the same as the shank 106b of the conventional tool 100b.

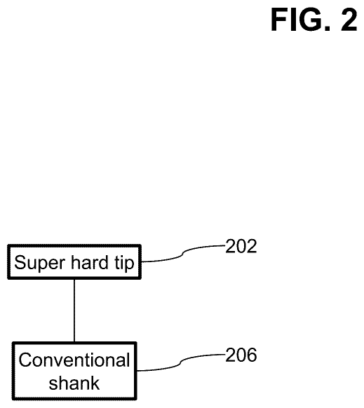

FIG. 2 is a block diagram of a super hard tipped tool in accordance with an embodiment of the current invention. For example, the tool may include a super hard tip 202 and/or conventional shank 206 and/or form that allows it to be used with a conventional CAM milling machine, optionally without modification and/or without special settings.

For example, the super hard tip 202 of the tool may include a PCD. For example, a PCD tip may be produced synthetically by sintering together many (Poly) diamond particles. Optionally, the diamond particles may be sized between 2 to 30 microns and or between 0.5 to 2 microns and/or between 30 to 60 microns. In some embodiments, the diamond particles may be sintered together with a binder. For example, the binder may include a metal binder (e.g., Cobalt). Optionally, the sintering is at high temperature and/or high pressure. Optionally, the tip 202 may consist of between 90-95% and/or between 75-90% diamond particles and/or between 50-75% diamond particles and/or between 50-75% diamond particles and/or between 95-99% diamond particles. For example, the rest may be binder.

In some embodiments, the hardness of the tip 202 may range between 5000 to 7000 HV Vickers hardness and/or between 7000 to 9000 HV Vickers hardness and/or between 5000 to 7000 HV Vickers hardness and/or between 3000 to 5000 HV Vickers hardness and/or between 9000 to 10000 HV Vickers hardness. The binder may increase the toughness of the tip. Optionally, the full nib of the tool may be PCD and/or PCD may be used for the cutting edge of the nib. Optionally the nib and/or the cutting edge may be machined using EDM (Electrical Discharge Machining). In some embodiments, the tool may be used for machining the prosthesis at between 1000 to 2000 mm/min and/or between 500 to 1000 mm/min and/or between 100 to 500 mm/min and/or between 2000 to 5000 mm/min and/or between 5000 to 10000 mm/min.

In some embodiments, a milling tool in accordance with the current invention may have a flute length of between 1 to 3 mm and/or between 3 to 5 mm and/or between to 1 mm and/or between 5 to 10 mm. For example, the flute length may be smaller than convention WC tools. Optionally, tool may have a reach of between 10 to 20 mm and/or between 5 to 10 mm and/or between 20 to 40 mm. Optionally, tool may have an overall length of between 20 to 50 mm and/or between 50 to 100 mm and/or between to 20 mm.

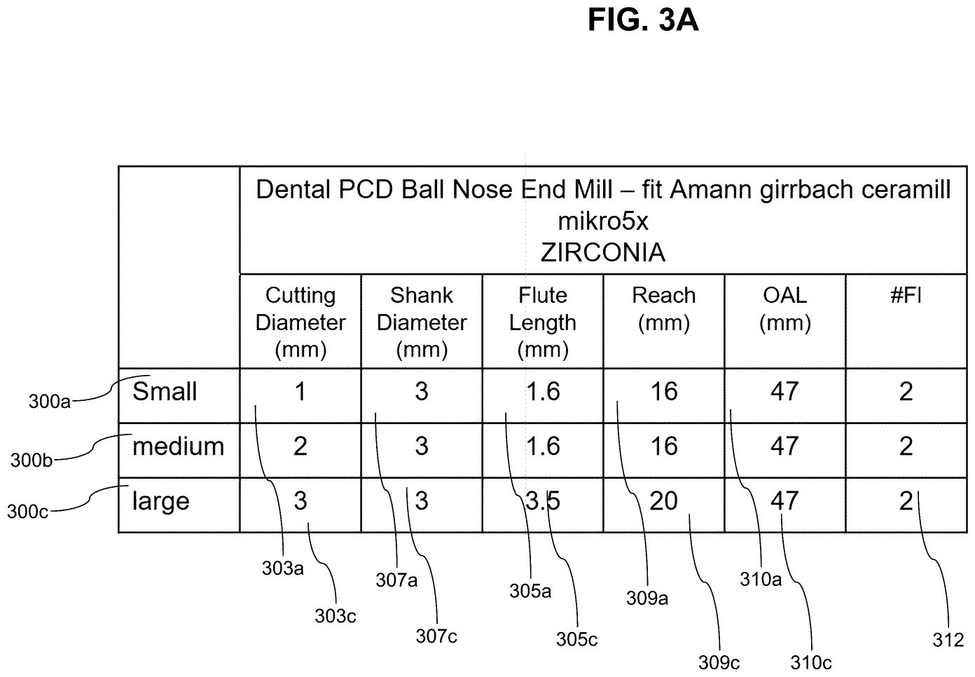

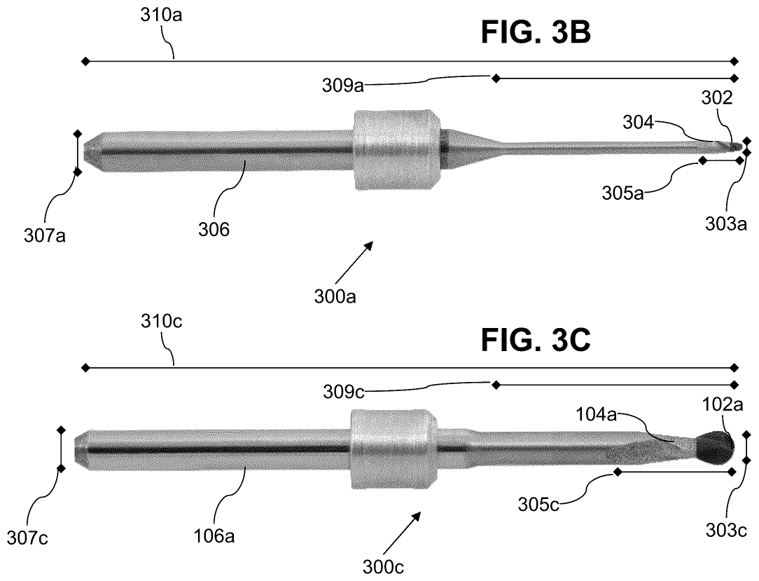

FIG. 3A is a table illustrating of some exemplary specifications for an end mill in accordance with an embodiment of the current invention. FIGS. 3B and 3C illustrate some exemplary ball tipped end mills with dimensions described in FIG. 3A in accordance with an embodiment of the current invention. For example, an end mill may be designed for use in an Amann Girrbach Ceramill Mikro5x. There may be a variety of sizes. For example, a small ball tipped endmill 300a may have a 3 mm cutting diameter 303a for a ball 302a and/or a 3 mm shank diameter 307a for a shank 306a and/or a flute length 305a of 3.5 mm for 2 flutes 304a and/or a reach 309a of 20 mm and/or an over all length 310a of 47 mm. For example, a large ball tipped endmill 300c may have a 3 mm cutting diameter 303c for a ball 102a and/or a 3 mm shank diameter 307c for a shank 306c and/or a flute length 305c of 3.5 mm for two 312 flukes 304c and/or a reach 309c of 20 mm and/or an over all length 310c of 47 mm.

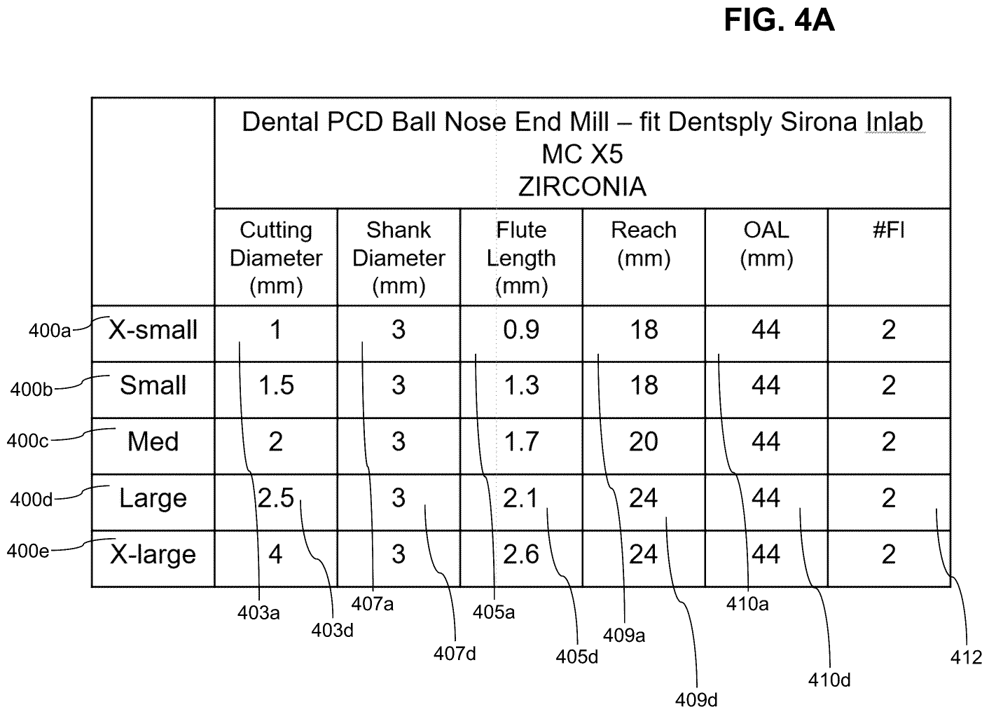

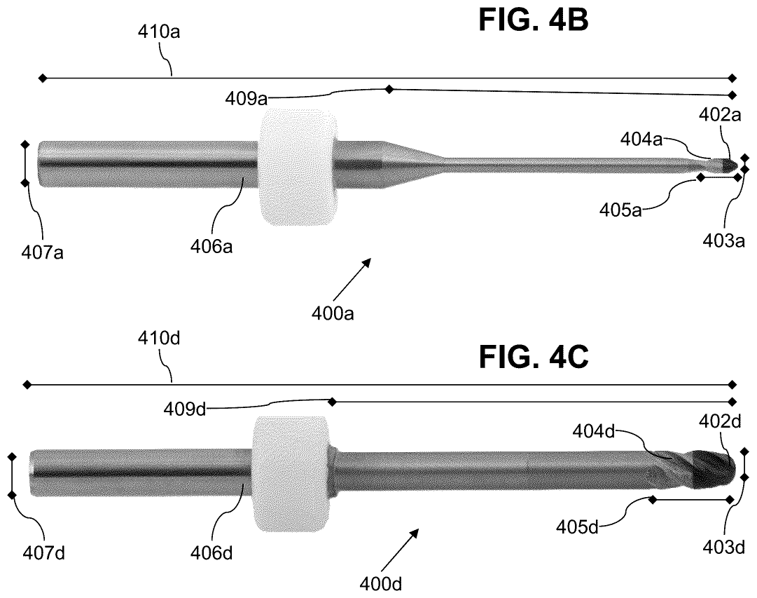

FIG. 4A is an illustration of some exemplary specifications for an end mill in accordance with an embodiment of the current invention. For example, specifications are illustrated for an extra small mill 400a, a small mill 400b, a medium mill 400c, a large mill 400d and/or an extra large mill 400e. FIGS. 4B and 4C illustrate some exemplary ball tipped end mills with dimensions described in FIG. 4A in accordance with an embodiment of the current invention. For example, in accordance with the current invention an end mill may be designed to fit and/or bet used with a Dentsply Sirona Inlab MC X5 CAM milling machine. There may be a variety of sizes. For example, an extra small ball tipped endmill 400a may have a 1 mm cutting diameter 403a ball 402a and/or a 3 mm shank diameter 407a for a shank 406a and/or a flute length 405a of 0.9 mm for 2 flutes 404a and/or a reach 409a of 18 mm and/or an over all length 410a of 44 mm. For example, a large ball tipped endmill 400d may have a 2.5 mm cutting diameter 403d for a ball 402d and/or a 3 mm shank diameter 407d for a shank 406d and/or a flute length 405d of 2.1 mm for two 412 flukes 404d and/or a reach 409d of 24 mm and/or an over all length 410d of 44 mm.

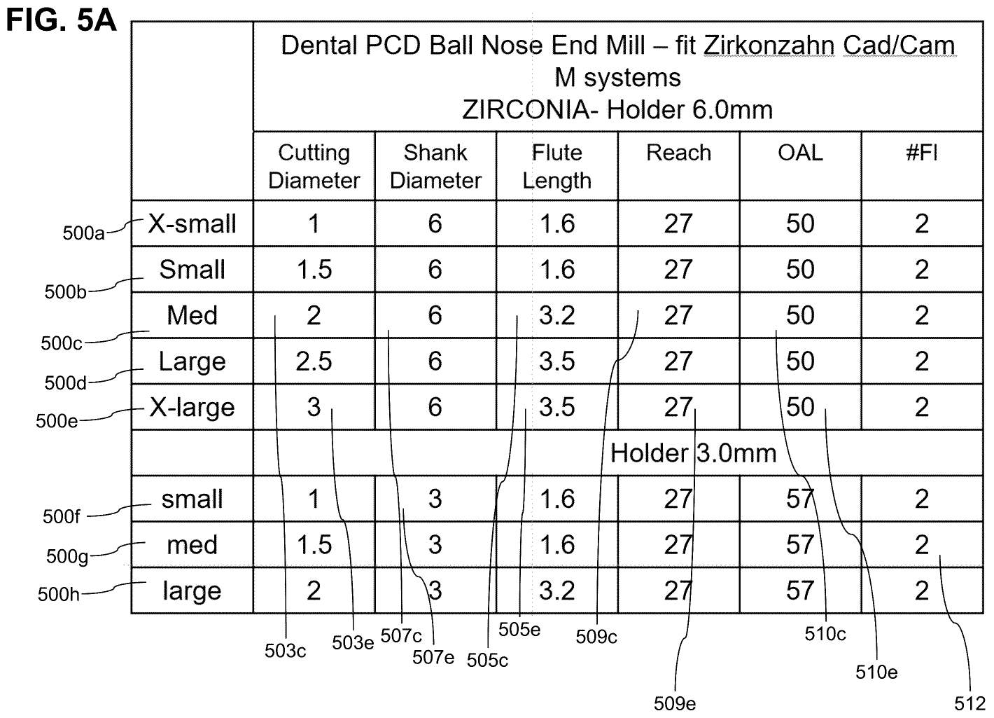

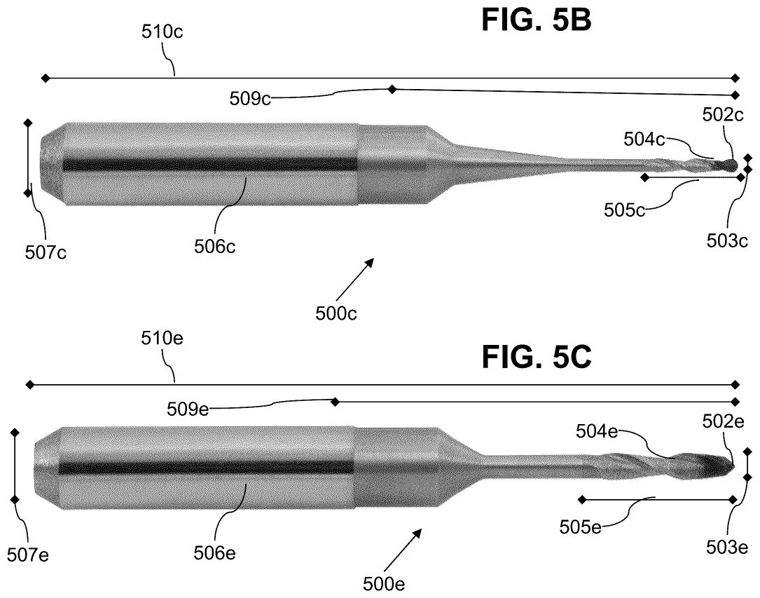

FIG. 5A is an illustration of some exemplary specifications for an end mill in accordance with an embodiment of the current invention. FIGS. 5B and 5C illustrate some exemplary ball tipped end mills with dimensions described in FIG. 5A in accordance with an embodiment of the current invention. For example, specifications are illustrated for an extra small mill 500a, a small mill 500b, a medium mill 500c, a large mill 500d and/or an extra large mill 500e with a thick 6 mm shank. For example, specifications are illustrated for a small mill 500f, a medium mill 500g, and a large mill 500h with a thin 3 mm shank. For example, in accordance with the current invention an end mill may be designed to fit and/or be used with a Zirkonzahn Cad/Cam M systems CAM milling machine. There may be a variety of sizes. For example, a medium ball tipped endmill 500c may have a 2 mm cutting diameter 503c ball 502c and/or a 6 mm shank diameter 507c for a shank 506c and/or a flute length 505c of 3.2 mm for 2 flutes 504c and/or a reach 509c of 27 mm and/or an over all length 510c of 50 mm. For example, an extra large ball tipped endmill 500e may have a 3 mm cutting diameter 503e for a ball 502e and/or a 6 mm shank diameter 507e for a shank 506e and/or a flute length 505e of 3.5 mm for two 412 flukes 504e and/or a reach 509e of 27 mm and/or an over all length 510e of 50 mm.

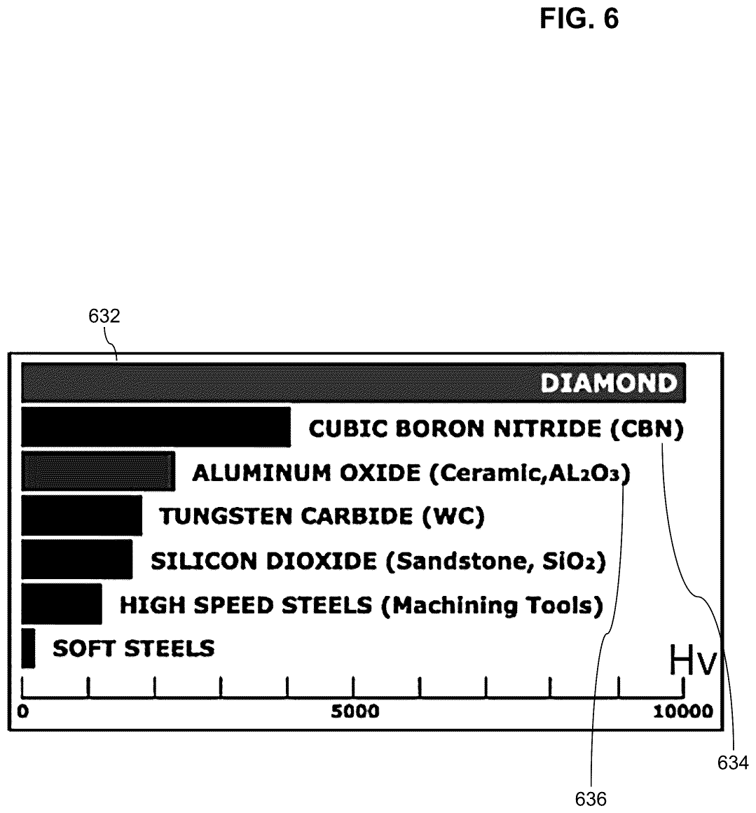

FIG. 6 is an illustration of the hardness of some exemplary materials that may be used for a machining tool in accordance with an embodiment of the current invention. For example, a super hard nib and/or cutting edge and/or tip may include Diamond 632, c-BC2N 634, y-Boron, c-BN 634, OsB4 and/or B4C and/or Al2O3 636.

In some embodiments, the mill rotation rate may range between 15,000 to RPM and/or between 25,000 to 50,000 RPM and/or between 5000 to 15,000 RPM. Optionally the cutting diameter may range between 1 to 3 mm and/or between 3 to 6 mm and/or between 0.25 to 1 mm and/or between 0.1 to 0.25 mm.

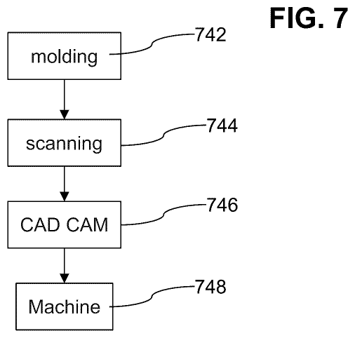

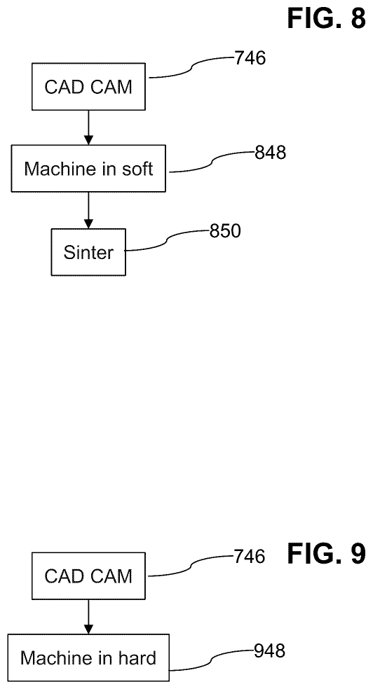

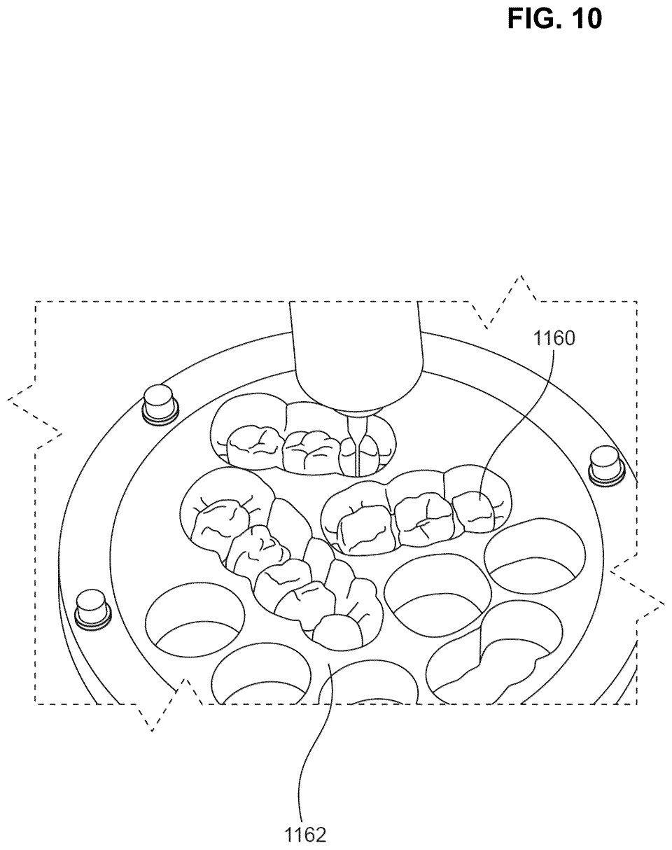

FIGS. 7 to 9 are flow chart illustrations of methods of Computer Aided Design CAD CAM machining in accordance with an embodiment of the current invention. In some embodiments, machining includes various steps of dentistry, for example, making a mold 742 of a patients mouth and/or scanning 744 the mouth and/or the mold (for example using a 3D scanner) and/or a 3D model of the desired prosthesis is generated 746 (e.g., by computer aided design CAD). Optionally, one or more prostheses are machined 748 (e.g., using computer aided machining CAM) from a block of material. For example, the block may be machined 848 in a green form (e.g., soft) and then hardened 850 (e.g., by sintering). For example, the hardness of the block being machined 848 may range between 50 to 200 HV Vickers hardness and/or between 200 to 1000 HV and/or between 1000 to 3000 HV and/or between 10 to 50 HV. Alternatively or additionally, the block may be machined 948 already in its hardened form (e.g., after sintering). For example, the hardness of the block being machined 948 may range between 1000 to 2000 H V Vickers hardness and/or between 2000 to 3000 HV and/or between 3000 to 7000 HV.

FIG. 10 illustrates machining multiple dental prostheses 1060 from a single block 1062 of material in accordance with an embodiment of the current invention. For example, a prosthesis 1060 made according to the current invention may include dentures, partial denture, palatal obturator, orthodontic appliance, dental implant, crown, bridge,

It is expected that during the life of a patent maturing from this application many relevant milling technologies, super hard materials, dental prosthetics and/or other technologies will be developed and the scope of the terms is intended to include all such new technologies a priori.

As used herein the term “about” refers to ±10%

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween. When multiple ranges are listed for a single variable, a combination of the ranges is also included (for example the ranges from 1 to 2 and/or from 2 to 4 also includes the combined range from 1 to 4).

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Various embodiments and aspects of the present invention as delineated hereinabove and as claimed in the claims section below find support in the following examples.

### EXAMPLES

Reference is now made to the following examples, which together with the above descriptions illustrate some embodiments of the invention in a non limiting fashion.

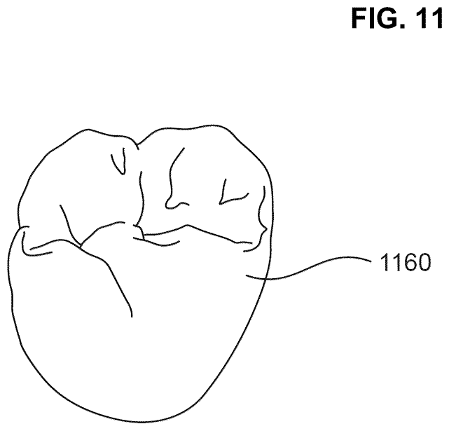

FIG. 11 illustrates a dental prosthesis 1160 that was produced in an exemplary process using an exemplary mill in accordance with some embodiments of the current invention. For example, the prosthesis 1160 was machined with a PCD ball nose mill. A 2.5 mm diameter mill was used for roughing and a 1.0 mm mill was used for finishing. A Amann Girrbach Ceramill mikro 5X was used with mills as illustrated for example in FIGS. 3A-3C. The turning speed was approximately 20,000 RPM at a cutting rate ranging between 1000 to 2000 mm/min. The PCD bit was able to produce 1300 crowns which is approximately 15-20 times or more as many as would be expected from a WC mill.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A tool for an existing CAM milling machine comprising:
a super hard tip.

2. The tool of claim 1, wherein the super hard is includes a diamond material.

3. The tool of claim 2, wherein the super hard tip includes a PCD.

4. The tool of claim 1, wherein a flute length of the tool is less than a convention WC tool.

5. The tool of claim 1, wherein a flute length of the tool is more than a convention WC tool.

6. The tool of claim 1, wherein the super hard tip is configured for cutting a green blank.

7. The tool of claim 1, wherein the super hard tip is configured for cutting a fully hardened blank.

8. The tool of claim 1, wherein the tool is configured for use in any cad cam machining center.

9. A method of cutting a dental prosthesis from a blank comprising:
supplying a fully hardened blank;
supplying a super hard tipped tool;
cutting the dental prosthesis from the fully hardened blank using the super hard tipped tool.

10. The method of claim 9, wherein said super hard tipped tool includes a PCD tip.

11. The method of claim 9, further comprising cutting multiple prostheses from said blank.

12. The method of claim 9, wherein said fully hardened blank comprises a hard ceramic.

13. The method of claim 12, wherein said fully hardened blank comprises sintered zirconium.

14. A method of cutting a dental prosthesis from a blank comprising:
supplying a green blank
supplying a super hard tipped tool
cutting the dental prosthesis from the green blank using the super hard tipped tool;
sintering said dental prosthesis after said cutting.

15. The method of claim 14, wherein said super hard tipped tool includes a PCD tip.

16. The method of claim 14, further comprising cutting multiple prostheses from said blank.

17. The method of claim 14, wherein said green blank comprises non sintered zirconium.
